(19) United States
(12) Patent Application Publication
(10) Pub. No.: US 2006/0277753 A1
(43) Pub. Date: Dec. 14, 2006

(54) Method of repairing a blade member

(75) Inventors: Marie-Christine Ntsama-Etoundi, La Ferte Alais (FR); Eric Pinto, Fleury En Biere (FR); Catherine Richin, Roinville Sous Dourdan (FR)

Correspondence Address: ROTHWELL, FIGG, ERNST & MANBECK, P.C., 1425 K STREET, N.W., SUITE 800, WASHINGTON, DC, 20005, US

(73) Assignee: SNECMA MOTEURS, Paris (FR)

(21) Appl. No.: 11/151,589

(22) Filed: Jun. 14, 2005

(30) Foreign Application Priority Data
Jun. 15, 2004 (FR) 04 06467

(51) Int. Cl. B23P 6/00; B23P 19/04

(52) U.S. Cl. 29/889.1; 29/402.08; 29/402.09; 29/402.11

(57) ABSTRACT

A method of repairing blade members, especially blade members in a turbomachine is provided. In one example, a damaged portion of a blade member is cut away from the blade member, by milling for example. The extent of the cut away portion generally corresponds in size and/or shape to the damaged area. A replacement portion is then welded into place in the resultant void in the blade member. The resulting weld seam is then burnished or deep rolled in order to cold work the blade member material at the weld seam. This induces compressive residual stresses in the blade member that counteract tensile residual stresses in and around the weld seam caused by the welding, and therefore strengthens the resulting repaired structure. The disclosed process particularly useful for repairing bladed disks (bladed monoblock disks) where individual blades cannot be removed for replacement or repair.

### FIELD OF THE INVENTION

The present invention relates to methods of repairing metallic blade members and, more generally, metallic blade-shaped members generally having a cross-sectional shape with an effective width that is substantially greater than a thickness thereof. The present invention especially, but not solely, relates to aerodynamic blade members used in turbomachinery such as turbines, aircraft engines, and the like.

### DESCRIPTION OF RELATED ART

Many known devices use bladed members, including turbines, jet aircraft engines, and the like. Moreover, depending on the application, such bladed members are made from metal or special metal alloys, and can be generally expensive to manufacture, maintain, and repair. Yet, over time and in the course of normal operation, these blades are generally subject to damage due to aging and wear. They also occasionally experience damage due to external factors such as foreign object damage in jet engines, problems occurring during the manufacture of constituent parts or during assembly, and design flaws. Damage may also include thermal and mechanical deformation, damage caused by vibration during operation, and damage caused by overheating during operation.

The damage may be in the form of, for example, pits, holes, cracks, and other deformities that may or may not be visible to the naked eye. Such damage must be addressed promptly so that it does not lead to grave problems such as general structural failure, which creates great potential for harm to property and people.

Even though physical damage to blades may be relatively localized, it is common practice to scrap an entire blade with an isolated damaged region rather than repair it. This is of course quite expensive, especially if a significant portion of the blade is still structurally sound.

In addition, with the advent of bladed disks (which are sometimes referred to in the art as “blisks,” and sometimes also known in the art as “bladed monoblock disks”), an inability to perform local repairs becomes very costly in the face of replacing an entire blisk assembly. In general, repair methods that contemplate separating a blade from its hub are by definition incompatible with the blisk structure. As a result, an entire blisk may be scrapped because of damage to just a few of the blades thereon.

Certain repair techniques are conventionally known. For example, U.S. Pat. No. 5,584,662 discloses filling a void formed in a vane by using a braze material similar to that constituting the vane. Laser shock peening is then used to induce deep (i.e., about 508 μm to 1270 μm) compressive residual stresses in the repaired area.

U.S. Pat. No. 6,568,077 also discloses a repair method that includes machining a damaged area using a milling machine to create a notch, followed by filling the notch in a welding step, using a filler material in powder or wire form. Finally, the welded repair is machined to restore proper shape characteristics. Laser shock peening or other after-repair steps are not used according to this document because the shape and size of the notch, and the corresponding welding process, are selected in a way so as to avoid maximum stress regions of the blade.

Finally, U.S. Pat. No. 6,238,187 describes a repair method in which a localized damaged area is cut away from, for example, a turbine blade. A replacement piece is provided that is at least generally similar in size, shape, and mechanical characteristics to the cut-away portion. The replacement piece is welded into place, and is thereafter shaped, if necessary, so as to conform with the overall original blade geometry. Finally, U.S. Pat. No. 6,238,187 discloses that laser shock peening “must” be used to process the weld seam and adjoining regions so as to develop compressive residual stresses in the region that counteract residual tensile fields in the material caused by the welding step.

However, laser shock peening is relatively expensive, time consuming, technically demanding, and usually entails significant startup costs, which can make it unacceptable for some applications, as mentioned in U.S. Pat. No. 6,415,486.

Where laser shock peening is not used to remedy the tensile stress effects of welding, it is also known to subject a repaired part to a thermal treatment followed by shot peening. The counteracting stresses induced as a result however are relatively weak.

In addition, it is known in the conventional art that brazing and other filling methods of repair sometimes suffer because the filler material does not match the mechanical characteristics of the original constituent metal. In addition, this approach means that the process of repair is dependent on the nature of the damage, such that it becomes difficult to establish a readily reproducible repair protocol.

### SUMMARY OF THE INVENTION

In view of the foregoing, the present invention is generally directed to a method of repairing damage to a metallic blade member that is more economical than the conventional methods discussed above, particularly with respect to the use of laser shock peening. Thus, the present invention includes, generally, cutting away or otherwise removing a damaged portion of the blade member, substituting a replacement portion for the removed portion, welding the replacement portion into place, and burnishing at least the resultant weld seam, if not the entire blade member surface.

Burnishing beneficially cold works the material of the blade member to induce compressive stresses in the repaired blade member. It is a particular feature of the present invention that the burnishing provides an effective but economical substitute for laser shock peening. These compressive stresses counteract residual stresses in the blade member structure caused by welding the replacement portion into place.

Preferably, the replacement portion has material characteristics that correspond closely with the material constituting the blade member so that approximately corresponding mechanical behavior can be realized.

The burnishing can be performed with an appropriate conventional tool, including a tool having, for example and without limitation, a fixed burnishing surface or a moveable burnishing surface. In the latter case, the moveable burnishing surface could be a roller element, such as, but not necessarily, a ball element appropriately supported so as to roll freely.

### BRIEF DESCRIPTION OF THE DRAWINGS

The present invention will be even better understood with respect to the appended drawings, in which:

FIGS. 1A-1F illustrate a method of repairing discrete damaged areas of a metallic blade member, such as a blade member in a turbine engine, according to the present invention;

FIGS. 2A-2E illustrate a method of repairing a damaged metallic blade member by replacing a major portion of the blade member, according to the present invention;

FIGS. 3 and 4 illustrate examples of a burnishing tool for use according to the present invention.

It is expressly emphasized here that all of the figures in the application are only examples, and are not limitative. For example, although only a discrete blade member is shown in the figures, the present invention is equally applicable to, for example, bladed disk (“blisk” or “monoblock”) configurations where the blade members are integrally formed with or otherwise fixed to the central disk in a known manner.

### DETAILED DESCRIPTION OF THE INVENTION

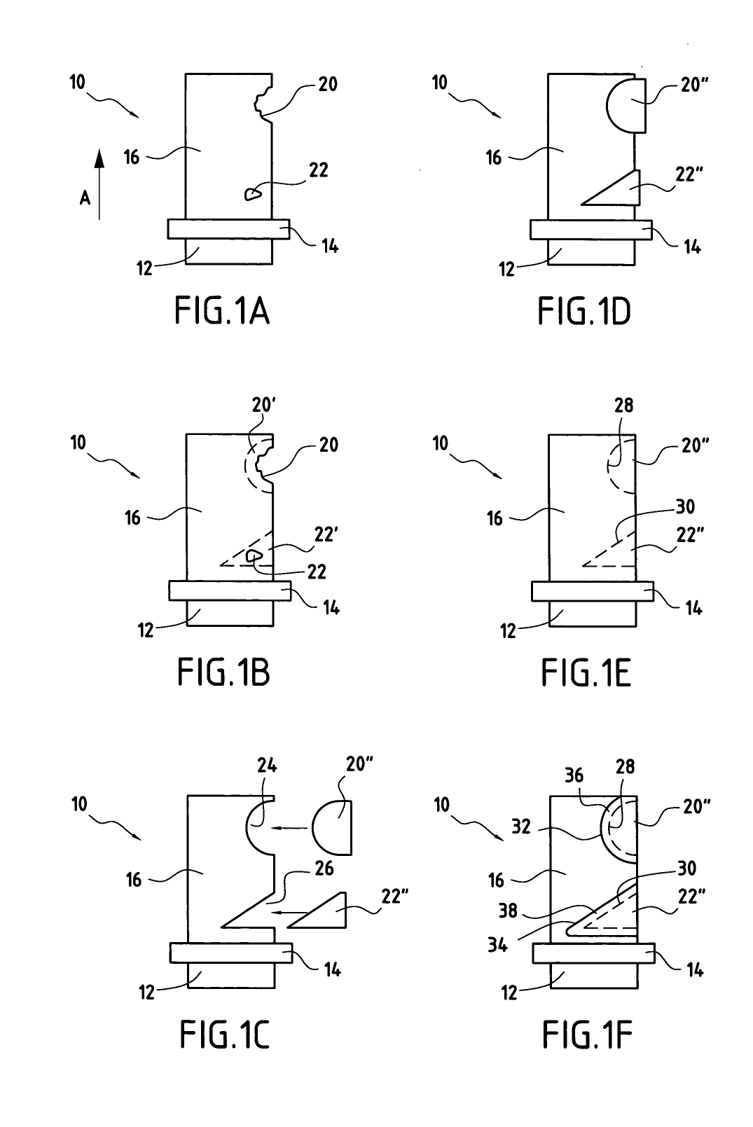

In a first preferred embodiment of the present invention, as illustrated in FIGS. 1A-1F, a localized damaged area of a blade member is repaired by cutting away a portion of the blade member generally conforming to the extent of the damaged area, and thereafter replacing the cut away portion with a similarly shaped replacement portion. This is generally advantageous because it minimizes the amount of the original constituent material removed from the blade member, thereby helping to largely maintain the original mechanical characteristics of the blade member.

FIGS. 1A-1F are side schematic views of a generalized blade member 10, particularly a blade member used in a turbomachine, such as a turbofan engine. In turbomachine applications, blade member 10 is made from any suitable metallic material, including metal alloys. Blade member 10, as illustrated, includes, for example, a root 12 for mounting blade member 10 in a disk (not shown) in a known manner, such as a dovetail fit. Platform 14 extends in a generally transverse direction and may abut a corresponding platform of an adjacent blade member when the blade members are mounted on a disk. Airfoil 16 extends outwardly from root 12 and platform 14 in a known manner, and has a leading edge generally indicated at 18. Airfoil 16 may have any desired aerodynamic profile, the specifics of which are not relevant to the present invention. FIG. 1A shows two highly schematic examples of blade member damage: a damaged leading edge portion 20, and a damaged surface portion 22.

Damage to airfoil 16 can occur for a variety of known reasons including and not limited to foreign object damage, mechanical fatigue caused by thermal cycling and strong centrifugal forces during operation, defects in design and/or manufacture, and chemical deterioration caused by an operating environment. The forms of damage can also be varied, including without limitation, surface punctures (like at portion 22), edgewise pitting (like at portion 20 at the leading edge), surface pitting, stellate cracks, and elongated cracks. Damage may be visible to the eye, or may be invisible to the eye but detectable by conventional technical inspection methods, including, without limitation, X-ray and sonic inspection.

As indicated in FIG. 1B, localized regions 20′ and 22′ corresponding to damaged portions 20 and 22, respectively, are identified. As noted above, according to one embodiment of the contemplated invention, the regions 20′ and 22′ at least generally correspond in size and/or shape to the damaged portions. On the one hand, it is known that relatively large or at least visible discrete damaged portions such as 20 and 22 are frequently associated with invisible or otherwise not readily apparent damage therearound. Therefore it is desirable to remove some of airfoil material surrounding the damaged portions so as to address this possibility. On the other hand, it is desirable to remove as little of the constituent material as possible, (although bearing in mind the foregoing issue of invisible damage), so as to preserve, overall, the original mechanical and metallurgical characteristics of the blade member 10. The shape of regions 20′ and 22′ may also depend on and be selected according to the particular stress fields present in a given blade member 10. These stress fields can be identified using well-known engineering techniques.

Regions 20′ and 22′ may be removed by any known method suitable for the materials and work environment in question. Any reference to “cutting away” and the like herein is meant to encompass any removal process appropriate for the structure and constituent material in question, including but not limited to cutting per se. Cutting per se is permissible according to the present invention, but in some cases can have negative side effects on the remaining structure. Another example of a suitable removal process is mechanical milling. Another example of a suitable removal process is cutting by known methods that preferably limit the amount of heat applied to the material. After regions 20′ and 22′ are removed, voids 24 and 26 remain in the blade member 10. It is desirable, according to the present invention, to remove regions 20′ and 22′ in a known, reproducible manner so that the geometries of resulting voids 24, 26 are known. This facilitates the use of replacement portions, as discussed above. Thus, for example, computer numerical control methods can be used in a known manner to control the above-mentioned examples of milling or cutting processes.

FIG. 1C illustrates the provision of replacement portions 20″ and 22″. As is discussed in U.S. Pat. No. 6,238,187, most generally, the creation of replacement portions 20″ and 22″ is preferably coordinated with the process of cutting away regions 20′ and 22′ so that the replacement portions 20″ and 22″ generally correspond to the resultant voids 24, 26. For example, the geometry of regions 20′ and 22′ may be predefined so as to correspond to predefined replacement portions 20″ and 22″, respectively. The replacement portions 20″ and 22″ may be, for example, individually formed as replacement elements by known methods such as molding or casting the same metallic material constituting the blade member 10. Alternatively, the replacement portions 20″ and 22″ may be cut from another “twin” blade member provided specifically for being cannibalized.

FIG. 1D illustrates replacement portions 20″ and 22″ put into place in corresponding voids 24 and 26, respectively. It will be noted that replacement portions 20″ and 22″ may be slightly oversized with respect to voids 24 and 26 in one or more dimensions, in anticipation of a later machining process. It is preferable, at minimum, that replacement portions 20″ and 22″ be oversized rather than undersized. The later machining process may include, for example, mechanical milling, manual grinding, or both.

Replacement portions 20″ and 22″ are then fixed in place relative to the blade member 10. In a preferred example, replacement portions 20″ and 22″ are fixed in place by an appropriate welding process, such as, without limitation, electron beam welding or gas tungsten arc welding.

If replacement portions 20″ and 22″ are oversized with respect to blade member 10 (as seen in a highly exaggerated form in FFIG. 1D), then a conventional machining process such as milling, manual grinding, or both, is performed to make the welded in place replacement portions 20″ and 22″ conform in dimension with the blade member 10. FIG. 1E illustrates the result of such a conventional machining process, thereby leaving weld seams 28 and 30.

However, welding the replacement portions 20″ and 22″ into place usually creates residual tensile stress in the structure, at least partly due to thermal effects from the welding. These tensile stresses cause weakness in the welded region and susceptibility to fatigue failure. Another source of material weakness is if the replacement portions are made from a material having properties not corresponding with the original blade member material.

It is therefore desirable to induce residual compressive stresses into the structure, e.g. by cold working the material. This cold working beneficially increases fatigue resistance and counteracts the tensile stresses induced during welding. According to the present invention, the cold working is performed by burnishing the weld region and/or portions adjacent thereto in order to induce the desired residual compressive stresses. Here, the mention of “burnishing” according to the present invention includes the more specific known concept of “deep rolling” (i.e. burnishing at relatively high loads, such as, for example, 100 bar to 400 bar (10⁷ pascals (Pa) to 4×10⁷ Pa)). In particular, deep rolling is known to provide significantly more cold working than, for example, laser shot peening.

In one example of the present invention, residual compressive stresses are induced to a depth of about 300 μm to about 1000 μm into the blade member structure. Preferably, the residual compressive stresses are induced to a depth of at least 800 μm.

Accordingly, FIG. 1F illustrates regions 36, 38 (defined by solid lines at 32, 34, respectively) over which burnishing or deep rolling according to the present invention is performed. It is noted here that regions 36, 38 as illustrated in FIG. 1F include substantially all of replacement portions 20″ and 22″, associated weld seams 28 and 30, and a relatively narrow region of the original blade member 10 adjacent to the weld seams 28 and 30. However, it is also useful according to the present invention to define a burnishing region that generally follows the weld seams 28 and 30 and includes only a narrow region of the original blade member material on one side and a narrow region of the replacement portion material on the other side. In addition, in one example of the present invention, burnishing is performed on both sides of blade member 10 in accordance with the foregoing considerations. More specifically, the burnishing performed on both sides can be performed generally simultaneously using at least two burnishing tools provided on respective sides of blade member 10. The burnishing tool according to the present invention is further discussed below.

The process illustrated in and described with respect to FIGS. 1A-1F is naturally illustrative and not limitative. For example, a single damaged region can be treated according to the present invention, just as more than two damaged regions can be treated.

The shape and size of the portion of the blade member 10 that is removed does not necessarily have to conform to the shape of the damaged portion of the blade member. For example, one or more predefined cutaway shapes can be used, the predefinition of such shapes thereby facilitating the preparation of corresponding replacement portions. It is desirable, nevertheless, to take away as little of the surrounding material as possible, balanced against the recognition that at least part of the blade member 10 adjacent to damaged portions 20 and 22 may have been subjected to difficult or impossible to see damage, such as microcracks or other sub-visible fractures. It is also desirable to take into consideration the stress fields present in the blade member when a damaged portion is removed or cut away, it being most preferable to define regions such as 20′ and 22′ along low stress areas of the blade member 10. The identification of low stress areas in this manner is known in the art.

Finally, it may be desirable according to the present invention to finish the repair process by shot-peening either just the repaired portion of the airfoil 16 or the airfoil 16 overall in a conventional manner in order to restore the surface stresses in the material and to make them relatively uniform.

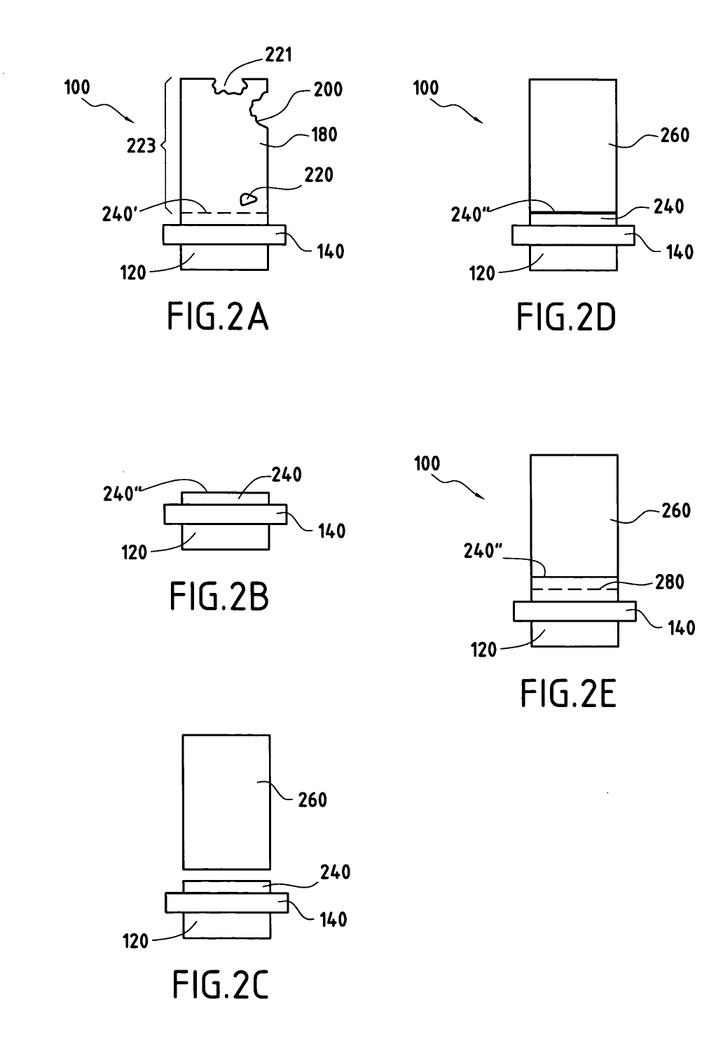

In some cases, the cumulative extent of damage to a blade member may be judged too extensive for multiple localized repairs as described above with respect to FIGS. 1A-1F. In this case, it may be necessary to replace a major portion of the airfoil of the blade member, as discussed with reference to FIGS. 2A-2E.

FIGS. 2A-2E are again side schematic views of a generalized blade member 100, particularly a blade member used in a turbomachine, such as a turbofan engine. As with blade member 10 discussed and described above, blade member 100 is preferably made from any metallic material, including metallic alloys, suitable for turbomachine applications. Blade member 100, as illustrated, includes, for example, a root 120 for mounting blade member 100 in a disk (not shown) in a known manner, such as a dovetail fit. Platform 140 extends in a generally transverse direction and may abut a corresponding platform of an adjacent blade member when the blade members are mounted on a disk. Airfoil 160 extends outwardly from root 120 and platform 140 in a known manner, and has a leading edge generally indicated at 180. Airfoil 160 may have any desired aerodynamic profile, the specifics of which are not relevant to the present invention. FIG. 2A shows three highly schematic examples of blade member damage: a damaged leading edge portion 200, a damaged surface portion 220, and a damaged tip portion 221.

Here, if the net damage to airfoil 160 is too great to justify (technically and/or economically) multiple localized repairs as discussed above with respect to FIGS. 1A-1F, then it may be useful and/or necessary to remove a major portion 223 of the airfoil 160 and replace it in a manner similar to the previously described procedure.

More specifically, FIG. 2B illustrates a remaining structure after a major portion 223 (see FIG. 2A) of airfoil 160 including damaged portions 200, 220, 221 has been removed by, for example, cutting or milling. The line 240′ at which the major portion of airfoil 160 is removed is preferably a low stress location with respect to the stresses present in the airfoil. In addition, unlike the embodiment of the present invention described above with respect to FIGS. 1A-1F, blade member 100 is here cut completely in a transverse direction relative to the direction A (see FIG. 2A) in which blade member 100 extends. In FIG. 2B, airfoil stub 240 is shown, including a cut surface 240″ to which a replacement portion will be subsequently attached.

FIG. 2C illustrates the provision of a replacement airfoil portion 260. As shown in FIG. 2D, replacement airfoil portion 260 is attached to airfoil stub 240, again preferably by welding (such as electron beam welding) to form a weld seam 240″. Inertia friction welding, as that term is known in the art, can also be used to attach replacement airfoil portion 260 to airfoil stub 240 and is particularly contemplated for repairing blisk structures.

The replacement airfoil portion can also be slightly oversized (i.e., thicker, wider, and/or taller) with respect to airfoil stub 240. In such a case, the oversized replacement airfoil portion would be machined in a suitable manner after being welded into place so as to conform with the original blade member configuration, similar to the process discussed and illustrated above in FIGS. 1D and 1E. It is preferable that a replacement airfoil portion be oversized rather than undersized with respect to airfoil stub 240.

Once the replacement airfoil portion 260 is welded into place (and machined into proper shape, if needed), a region 280 (FIG. 2E) of the airfoil at or at least adjacent to weld seam 240″ is burnished or deep rolled in a manner similar to that described above relative to FIGS. 1A-1F. This burnishing induces residual compressive stresses in the blade member so as to counteract residual tensile stress caused when welding replacement airfoil portion 260 into place. Here again, it is important to cause sufficient cold working so as to strengthen weld seam 240″ and the surrounding material structure so as to provide a durable, good quality blade repair. Preferably, residual compressive stresses are induced to a depth of about 300 μm to about 1000 μm into the blade member structure. Preferably, the residual compressive stresses are induced to a depth of at least 800 μm.

As discussed above, the burnishing or deep rolling performed according to the present invention can be carried out with any known burnishing or deep rolling tool as long as it is able to carry out the desired level of cold work hardening to the appropriate depth. The selected tool may be applied in a non-repeating and/or non-overlapping track on the airfoil surface or it may be applied in a more random manner that may include tracks that overlap each other one or more times. The path along which burnishing or deep rolling is performed may be controlled and/or defined by known tool control methods, including for example, computer numerical control (“CNC”) methods.

The pressure applied by the tool may be constant over the entire region processed, or it may selectively vary in a continuous or in a discontinuous manner. The tool may be provided with a freely moving tip such as a rolling ball or other rolling press member, or it may comprise a non-moving burnishing head, usually rounded in configuration.

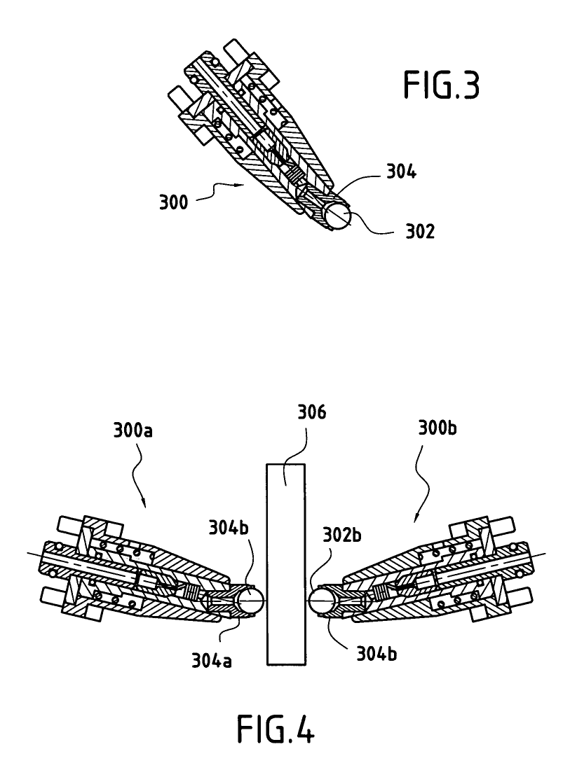

Examples of rolling ball burnishing and deep rolling tools are known in the art and are disclosed in, for example, U.S. Pat. No. 6,415,486, U.S. Pat. No. 5,826,453, published U.S. application 2002/0174528, and U.S. Pat. No. 4,947,668. In general, these tools provide a ball member in some form of socket so that the ball is free to roll as the tool is moved relative to the surface being burnished (or more precisely rolled). FIG. 3 illustrates, very schematically, an example of a burnishing tool 300 including a rolling ball member 302 held in a socket 304. The ball member 302 may be, for example and without limitation, hydrostatically supported by pressurized fluid to be freely moveable in socket 304, as is well-known in the art. Instead of a ball member in a socket, a rotating roller member (not shown) or a blunt or rounded fixed (i.e., static) tip may also be used.

In the case of a burnishing tool using a rolling ball member, the force (i.e., load) applied by the tool may depend on several factors, including the diameter of the ball member, the material of the ball member, and the pressure of the fluid supporting the fluid member. The force may also depend on and be controlled by the manner in which the tool is mounted, such as, for example, on a tooling table, a robotic arm, etc.

As mentioned above, it may be desirable to burnish both sides of an airfoil portion at the same time according to the present invention, especially to avoid deformation due to burnishing pressure being applied to only one side of an airfoil. Thus, FIG. 4 illustrates, very schematically, a burnishing arrangement that permits burnishing of both sides. In FIG. 4, two burnishing tools 300a, 300b are provided. The burnishing tools 300a, 300b each have a general structure like tool 300 in FIG. 3, for example, or like any known burnishing tool, so a detailed explanation will be omitted here. In one particular arrangement, the tools 300a, 300b are mounted on a caliper-like apparatus (not shown here) so that a generic blade member portion 306 is disposed therebetween. Most preferably, the respective ball members 302a, 302b (or, more generally, the respective points at which the tools contact blade member portion 306, if ball members are not used) are oriented so that they substantially oppose each other on opposite sides of blade member portion 306.

What is claimed is:

1. A method of repairing a damaged metallic blade member comprising:
removing a damaged portion of the blade member;
substituting a replacement portion for the damaged portion; and
welding the replacement portion into place;
wherein at least a welded region of the blade member by which the replacement portion is fixed in place is burnished.

2. The method according to claim 1, wherein burnishing includes deep rolling.

3. The method according to claim 1, wherein burnishing comprises ball burnishing.

4. The method according to claim 3, wherein at least the welded region of the blade member by which the replacement portion is fixed in place is ball burnished using a tool having a moveable ball member for applying pressure.

5. The method according to claim 4, wherein the tool comprises a moveable ball member hydrostatically supported in a socket.

6. The method according to claim 1, further including shot-peening at least a portion of the welded region after burnishing.

7. The method according to claim 1, wherein removing the damaged portion of the blade member comprises milling away the damaged portion of the blade member.

8. The method according to claim 1, wherein removing the damaged portion of the blade member comprises cutting the blade member.

9. The method according to claim 1, wherein removing the damaged portion of the blade member comprises removing a portion of the blade member corresponding in at least one of size and shape to the damage present.

10. The method according to claim 1, wherein removing the damaged portion of the blade member comprises removing a distal portion of the blade member along a plane generally transverse to a direction in which the blade member extends.

11. The method according to claim 1, wherein both sides of the blade member are burnished simultaneously.

12. The method according to claim 1, further comprising machining the welded replacement portion so as to conform the replacement portion to the blade member.

13. The method according to claim 12, wherein machining the welded replacement portion comprises at least one of machine milling and manual grinding.

14. A method of repairing a damaged metallic blade member of a bladed monoblock disk of a turbomachine according to claim 1.
